(19) United States
(12) Patent Application Publication
(10) Pub. No.: US 2015/0300084 A1
(43) Pub. Date: Oct. 22, 2015

(54) COVERING DEVICE FOR OPENINGS, IN PARTICULAR FOR MACHINE OPENINGS

(71) Applicant: Hennig Holding GmbH, Kirchheim (DE)

(72) Inventor: Kurt Schönerwald, Vilsheim (DE)

(21) Appl. No.: 14/619,636

(22) Filed: Feb. 11, 2015

(30) Foreign Application Priority Data
Feb. 11, 2014 (DE) DE102014202471.4

(51) Int. Cl. E06B 9/40; E06B 9/68

(52) U.S. Cl. CPC E06B 9/40; E06B 9/68

(57) ABSTRACT

A covering device for machine openings includes a shaft and a winding body which can be rotated relative to one another. A spring element is prestressed between the shaft and the winding body and is mounted by a first spring end to the winding body and by a second spring end to the shaft. A covering element can be wound and unwound onto the winding body to open and cover the opening, respectively. A coupling mechanism couples movement of the covering element to a rotational movement of the shaft. The coupling mechanism has at least one coupling wheel coupled to the shaft that has a profile which is engaged with a counter-profile on the covering element. The loading of the spring element is kept substantially constant by the coupling mechanism as the spring ends are displaced substantially synchronously during the winding and unwinding about the rotational axis.

### CROSS-REFERENCES TO RELATED APPLICATIONS

This application claims the priority of German Patent Application, Serial No. 10 2014 202 471.4, filed Feb. 11, 2014, pursuant to 35 U.S.C. 119(a)-(d), the content of which is incorporated herein by reference in its entirety as if fully set forth herein.

### FIELD OF THE INVENTION

The invention relates to a covering device for openings, in particular for machine openings, comprising a winding unit with a shaft that is rotatable about a rotational axis, a winding body that is rotatable about the rotational axis, and a spring element for producing a prestressing force acting between the shaft and the winding body, wherein the spring element is mounted by a first spring end on the winding body and by a second spring end on the shaft, the covering device further comprising a covering element to cover an opening, which to open the opening is windable onto the winding body and to cover the opening is unwindable from the winding body, the covering device further comprising a coupling mechanism for coupling a movement of the covering element to a rotational movement of the shaft.

### BACKGROUND OF THE INVENTION

A covering device having a winding unit for winding and unwinding a covering element is known from DE 10 2012 200 642 A. The winding unit comprises a winding body and a shaft, which are prestressed against one another by means of a spring element about an associated rotational axis. For this purpose, a first spring end is non-rotatably arranged by means of a bearing on the winding body and a second spring end is non-rotatably arranged on the shaft by means of a counter-bearing. In order to keep the loading of the spring element substantially constant during the winding and unwinding movement and to produce a substantially constant prestressing force, a rotation of the counter-bearing or the shaft also takes place upon a rotation of the bearing or of the winding body. A coupling mechanism is provided for this, which couples the winding and unwinding movement of the covering element to a rotational movement of the shaft or the counter-bearing. This takes place by means of a continuous coupling element in the form of a chain, which is connected by a connecting element to the free end of the covering element and is engaged with a toothed wheel, which is non-rotatably arranged on the shaft. The linear movement of the covering element is converted into a rotational movement of the shaft or the counter-bearing by this coupling mechanism, so the counter-bearing is rotated in accordance with the winding body or the bearing.

A drawback in the known covering device is that the structure of the coupling mechanism is complicated. This applies, in particular, when the covering device is to have a large covering lift, as the continuous coupling element or the chain has to extend along the entire covering lift. Moreover, in the case of large covering lifts, the reliability of the covering device is no longer ensured, as during operation of the covering device malfunctions of the coupling mechanism, in particular of the continuous coupling element, occur.

### SUMMARY OF THE INVENTION

The invention is based on an object of providing a covering device having a simpler and more reliable structure.

This object is achieved by a covering device in which the coupling mechanism has at least one coupling wheel coupled to the shaft, and in which a profile of the at least one coupling wheel is engaged with a counter-profile arranged on the covering element. The coupling of the winding and unwinding movement of the covering element and the rotational movement of the shaft takes place by means of the at least one coupling wheel, which engages with its peripheral profile in a counter-profile arranged on the covering element. The counter-profile extends over the length of the covering lift along the movement direction of the covering element. The covering element is preferably configured as a link apron. The at least one coupling wheel with the peripheral profile as well as the associated counter-profile therefore replace the continuous coupling element known from the prior art. The structure of the covering device according to the invention is therefore simpler and more reliable. In particular, covering lifts of any size can be realised with the structure according to the invention in that the counter-profile is easily lengthened in the movement direction of the covering element. The reliability of the covering device is therefore independent of the size of the covering lift. The at least one coupling wheel is preferably arranged adjacent to the winding unit, so a simple coupling of the rotational movement of the shaft and the at least one coupling wheel is achieved. The covering element is, in particular, rigid for sliding. This means that the covering element allows a sliding movement.

A covering device, in which the counter-profile is formed by individual counter-profile elements, which are configured, in particular, in the manner of a pin ensures a simple structure of the counter-profile. The counter-profile is formed by individual counter-profile elements, which are separate from one another. The counter-profile elements are arranged at a substantially constant spacing from one another on the covering element. This means that the adjacent counter-profile elements have a constant spacing from one another. The at least one coupling wheel has recesses on the periphery, which correspond with respect to their shape and their spacing to the counter-profile elements. Since the counter-profile is formed by individual counter-profile elements, the length of the counter-profile can easily be adapted to the covering lift.

A covering device, in which the covering element is configured as a link apron with a plurality of links connected to one another in an articulated manner and the counter-profile, in particular the counter-profile elements, is arranged on the links, easily ensures a high degree of reliability. The link apron has a high inherent stability, so a sliding movement of the link apron can easily be carried out. A sliding movement takes place, for example, when the shaft is rotatably driven by a drive motor and the at least one coupling wheel converts the rotational movement into a sliding unwinding movement. Furthermore, a sliding movement takes place, for example, when the free end of the link apron is arranged on a moving component, for example a tool spindle of a machine, and the component is moved in the direction of the winding unit so a sliding winding movement takes place. Moreover, the link apron can absorb high pressure loads transverse to its surface, so the latter can be walked on, in particular.

A covering device, in which the counter-profile elements are arranged laterally on the covering element, in particular on the end face of the links, ensures an easy attachment of the counter-profile. The counter-profile elements extend laterally from the covering element. The counter-profile elements are preferably arranged on the end face of the links, in that the latter are fastened, in particular, in a cavity, which is open on the end face, of the respective link.

A covering device, in which to secure the engagement of the profile and counter-profile, a counter-holder is associated with the at least one coupling wheel, ensures a high degree of reliability. The counter-holder ensures a secure engagement of the profile and counter-profile. For this purpose, the counter-holder prevents the counter-profile displacing upon a winding or unwinding movement transverse to the movement direction and leaving the profile so the engagement is no longer ensured. The at least one coupling wheel and the counter-holder preferably form a gap, in which the counter-profile, in particular the counter-profile elements, are guided in regions.

A covering device, in which the counter-profile elements are configured as sliding elements and/or rolling elements and/or guide elements, ensures a simple structure. The counter-profile elements are also used as sliding elements and/or rolling elements and/or guide elements, so the covering element can move along the covering lift by means of the counter-profile elements. The provision of separate sliding elements and/or rolling elements and/or guide elements can therefore be dispensed with. The counter-profile elements are, in particular, made of a plastics material to achieve a low-friction movement or guidance. Alternatively, the counter-profile elements may be made of metal and slide in a guide made of plastics material. In addition, the counter-profile elements may be configured as rolling elements, which ensure an as far as possible low-friction movement of the covering element. Moreover, the counter-profile elements may also be configured as guide elements, which guide the covering element.

A covering device, in which the counter-profile elements are guided in a guide, ensures a reliable opening and covering of the opening. The guide has, in particular, at least one guide rail, which is U-shaped in cross section. The guide preferably has two guide rails, which are arranged on both sides of the covering element and in which the covering element is guided by means of the counter-profile elements. The counter-profile elements are, in particular, configured as sliding elements and/or rolling elements and/or guide elements.

A covering device, in which the shaft is non-rotatably connected to a first profile wheel and the at least one coupling wheel is non-rotatably connected to a second profile wheel and in which the profile wheels are coupled by a continuous coupling element, easily ensures a coupling of the at least one coupling wheel and the shaft. The continuous coupling element is, for example, configured as a toothed belt or chain. The length of the continuous coupling element is independent of the covering lift and can be selected to be extremely short as only the rotational movements of the shaft and the coupling wheel have to be coupled to one another.

A covering device, in which the coupling mechanism has two coupling wheels arranged on both sides of the covering element, and in which the respective profile of the coupling wheels is engaged with the associated counter-profile arranged on the covering element, ensures a high degree of reliability as a uniform winding and unwinding movement results from the coupling on both sides. The coupling mechanism is, in particular, identically constructed on both sides of the covering element.

A covering device, in which a bearing is non-rotatably arranged on the winding body and a counter-bearing is non-rotatably arranged on the shaft, and in which the first spring is arranged on the bearing and the second spring end is arranged on the counter-bearing, ensures a simple structure. Owing to the bearing and the counter-bearing, a non-rotatable connection of the ends of the spring element to the winding body or to the shaft is easily achieved.

A covering device, in which the spring element is arranged within the winding body and, in particular, is configured as a helical spring, ensures a simple and robust structure. The spring element is arranged in a cavity between the winding body and the shaft. The spring element is prestressed by torsion. The configuration as a helical spring is simple and robust.

A covering device, in which the coupling mechanism is drivable by means of a drive motor, the drive motor in particular being coupled to the shaft, allows an automatic covering and opening of the opening. The drive motor is, in particular, coupled to the shaft, so that a winding and unwinding movement of the covering element can be produced by the rotational movement of the rotatably driven shaft—depending on the rotational direction—by means of the coupling mechanism. Alternatively, the covering device may not have its own drive motor, but be operated by an external drive motor, which brings about a winding and unwinding movement of the covering element. The external drive motor is, for example, a drive motor of a production machine or machine tool, which displaces a component of the machine, the component being coupled to the free end of the covering element. The winding and unwinding movement of the covering element is in this case converted by means of the coupling mechanism into a rotational movement of the shaft or counter-bearing.

Further features, advantages and details of the invention emerge from the following description of a plurality of embodiments.

### BRIEF DESCRIPTION OF THE DRAWINGS

FIG. 1 shows a perspective view of a covering device according to a first embodiment,

FIG. 2 shows a frontal view of the covering device in FIG. 1,

FIG. 3 shows a side view of the covering device in FIG. 1,

FIG. 4 shows an axial section through a winding unit of the covering device along the section line IV-IV in FIG. 3 and

FIG. 5 shows a perspective view of a covering device according to a second embodiment.

### DESCRIPTION OF THE PREFERRED EMBODIMENTS

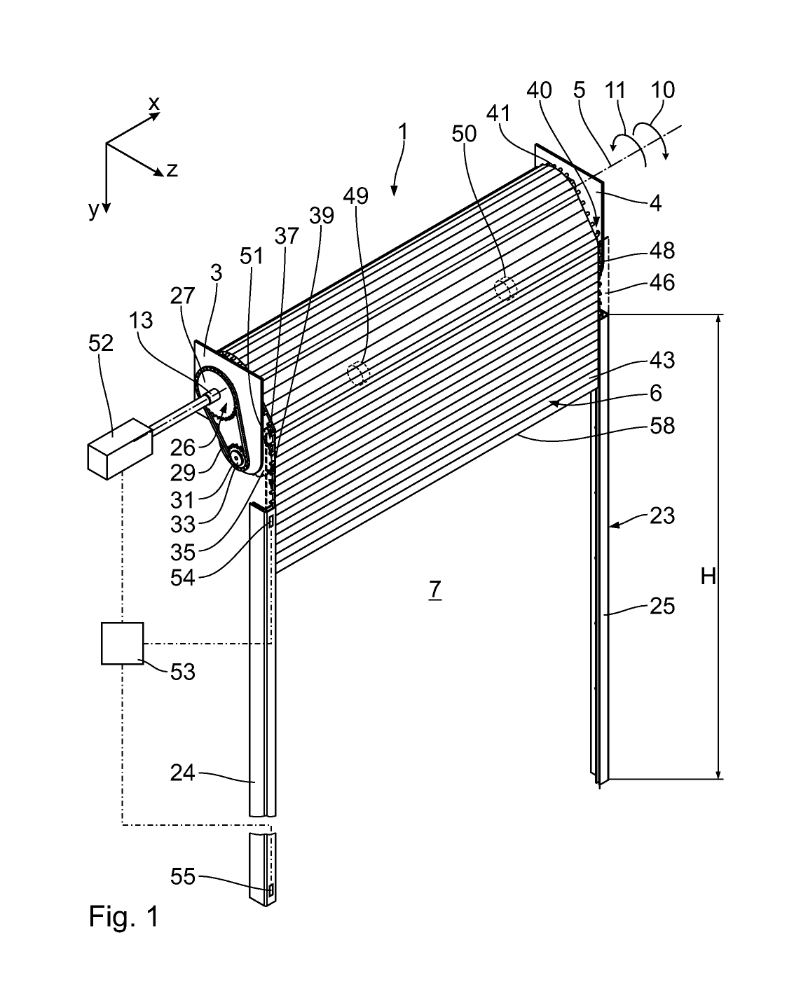

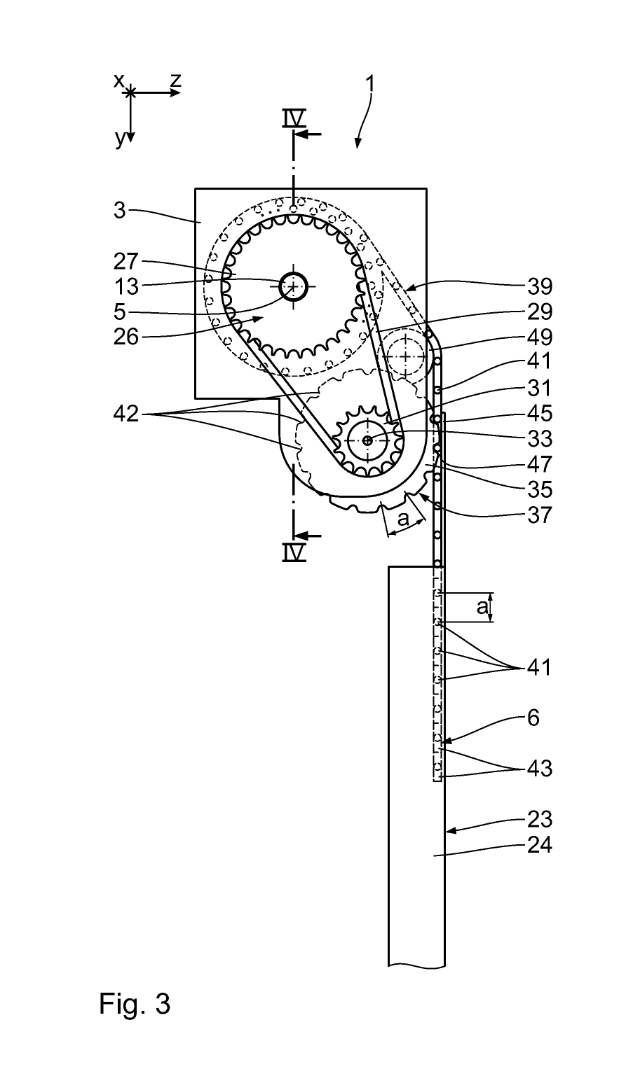

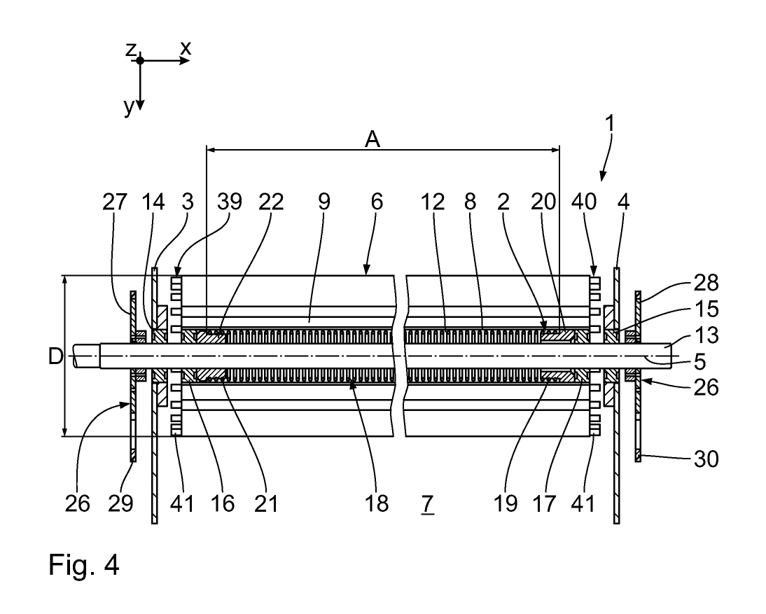

A first embodiment of the invention will be described below with reference to FIGS. 1 to 4. A covering device 1 has a winding unit 2, which is arranged between two base bodies 3, 4. The winding unit 2 is rotatably mounted on the base bodies 3, 4 about a rotational axis 5. The rotational axis 5 extends in an x-direction. Fastened to the winding unit 2 is a covering element 6, which can be wound and unwound by means of the winding unit 2. The covering element 6 is used to cover an opening 7. The opening 7 to be covered is, for example, a machine opening. Machine openings of this type are, in particular, configured on production machines and/or machine tools.

The winding unit 2 has a winding body 8, on which the windable covering element 6 is fastened by a first end 9. To cover the opening 7, the winding body 8 can be rotated in a first rotational direction 10 about the rotational axis 5, so the covering element 6 is unwound. In contrast, the winding body 8 can be rotated in a second rotational direction 11 about the rotational axis 5 to open the opening 7, so the covering element 6 is wound.

The winding body 8 is configured as a hollow cylinder and delimits an interior 12. A shaft 13, which is arranged concentrically with respect to the rotational axis 5, is guided through the interior 12. The shaft 13 is rotatably mounted on the base bodies 3, 4 by means of bearing elements 14, 15. Furthermore, the shaft 13 is rotatably mounted on the winding body 8 by means of bearing elements 16, 17, so the winding body 8 and the shaft 13 can be pivoted or rotated relative to one another.

To produce a prestressing force F acting on the winding body 8, a spring element 18 is arranged in the interior 12. The spring element 18 is configured as a helical spring and arranged substantially coaxially to the rotational axis 5. The spring element 18 is mounted by a first spring end 19 on a bearing 20, which is rigidly connected to the inside of the winding body 8. In contrast, a second spring end 21 of the spring element 18 is mounted on a counter-bearing 22, which is rigidly connected to the shaft 13. The counter-bearing 22 is therefore rotatable relative to the bearing 20 about the rotational axis 5.

The covering element 6 is configured as a link apron and has a large number of links 43, which are connected to one another in an articulated manner. The links 43 extend in the x-direction, so the link apron extends along the x-direction and a y-direction running perpendicular thereto. The covering element 6 is guided in a guide 23, which comprises two guide rails 24, 25 that are U-shaped in cross section. The guide rails 24, 25 are arranged spaced apart from the rotational axis 5 in a z-direction running perpendicular to the x- and y-direction and extend in the y-direction.

The covering device 1 has a coupling mechanism 26 to couple the rotational movement of the shaft 13 and the winding and unwinding movement of the covering element 6. The coupling mechanism 26 comprises two first profile wheels 27, 28, which are non-rotatably arranged on the shaft 13 on both sides of the base body 3, 4. The first profile wheels 27, 28 are coupled by means of associated continuous coupling elements 29, 30 to second profile wheels 31, 32, which are arranged on both sides of the base bodies 3, 4 in accordance with the first profile wheels 27, 28. The profile wheels 27, 28 and 31, 32 are configured as toothed wheels. The continuous coupling elements 29, 30 are configured as chains. The second profile wheels 31, 32 are non-rotatably connected to coupling wheels 35, 36 by means of associated shafts 33, 34. The coupling wheels 35, 36 are arranged on the sides of the base bodies 3, 4 facing the covering element 6. The shaft 13 and the coupling wheels 35, 36 are coupled to one another in this manner.

The coupling wheels 35, 36 each have a profile 37, 38 on the periphery, which in each case engages in an associated counter-profile 39, 40. The counter-profiles 39, 40 are arranged at the ends of the covering element 6 in the x-direction, in other words on the two end faces of the covering element 6.

The counter-profiles 39, 40 are formed by individual counter-profile elements 41, which are configured in a pin-like or bolt-like manner. The counter-profile elements 41 are arranged laterally on the covering element 6 in the x-direction and thus project beyond the covering element 6 in the x-direction. The counter-profile elements 41 pair-wise have the same spacings a from one another, correspondingly spaced recesses 42, which form the respective profile 37, 38, being formed on the coupling wheels 35, 36 on the peripheral side. The counter-profile elements 41 are fastened at the end face on both sides of each link 43. For this purpose, the counter-profile elements 41 are inserted in a cavity 44 that is open on the end face of each link 43 and fastened there.

To secure the engagement of the respective profile 37, 38 and the associated counter-profile 39, 40, counter-holders 45, 46 are associated with the coupling wheels 35, 36. The counter-holders 45, 46, together with the associated coupling wheel 35, 36, form a gap 47, 48, through which the counter-profile elements 41 are guided with little play. The counter-holders 45, 46 are arranged on the guide rails 24, 25 and extend in the direction of the coupling wheels 35, 36 to form the respective gap 47, 48. The counter-holders 45, 46 therefore secure the counter-profile elements 41 in the associated recesses 42 of the coupling wheels 35, 36.

The counter-profile elements 41 are also used as sliding elements and/or rolling elements and/or guide elements for the movement of the covering element 6 in the guide 23. For this purpose, the counter-profile elements 41 are guided in the U-shaped guide rails 24, 25. The counter-profile elements 41 are, for example, made of plastics material and/or metal. This allows low-friction guidance.

To deflect the covering element 6 parallel to the guide rails 24, 25, two deflection rollers 49, 50 are arranged between the base bodies 3, 4. The deflection rollers 49, 50 are rotatably mounted on a carrier 51, which is fastened to the base bodies 3, 4.

An electric drive motor 52 is coupled to the shaft 13 to rotatably drive the profile wheels 27, 28. To control the drive motor 52, the latter has a signal connection to a control unit 53, which is in turn connected to two end switches 54, 55. The end switches 54, 55 are arranged at the end of the guide 23.

The mode of functioning of the covering device 1 is as follows:

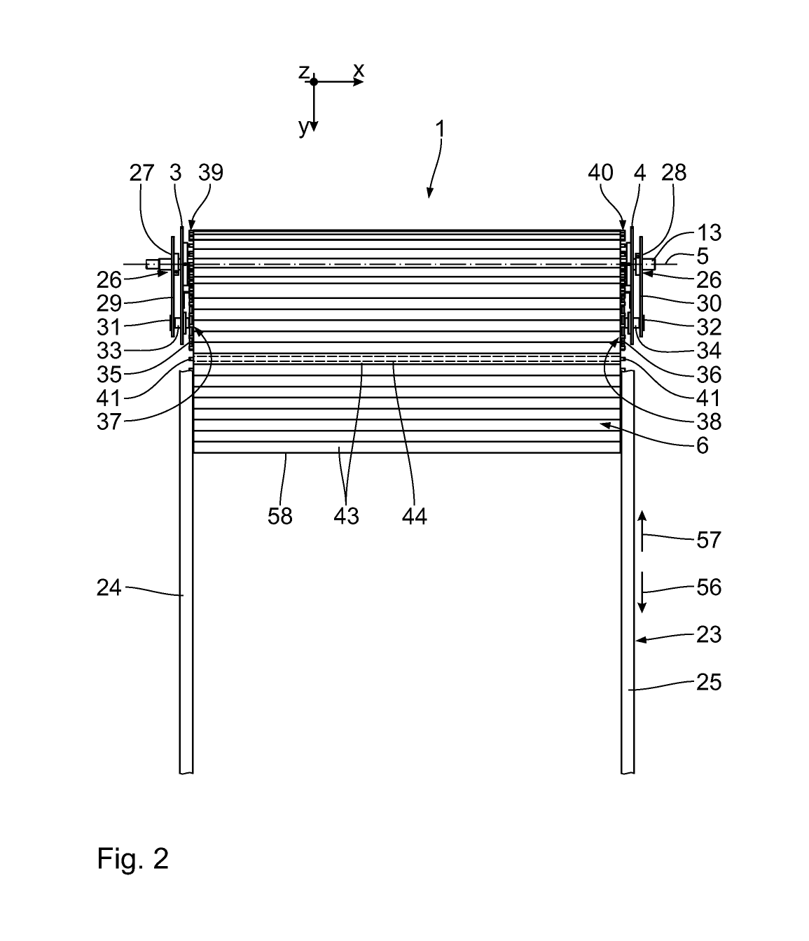

The opening 7, as shown in FIGS. 1 and 2, is firstly open and is to be covered. For this purpose, the drive motor 52 is driven in such a way that the shaft 13 is rotated in the rotational direction 10. The rotational movement of the shaft 13 is transmitted by the profile wheels 27, 28 to the continuous coupling elements 29, 30, which in turn transmit their movement to the profile wheels 31, 32. The coupling wheels 35, 36 are rotatably driven by means of the profile wheels 31, 32 by the shafts 33, 34. Since the profile 37, 38 of the coupling wheels 35, 36 is engaged with the associated counter-profile 39, 40, the covering element 6 is moved in a covering direction 56. The rotational movement of the shaft 13 is therefore converted by means of the coupling mechanism 26 into a linear movement or unwinding movement of the covering element 6.

During the unwinding, the counter-profile elements 41 are engaged with the associated recesses 42. The counter-holders 45, 46 prevent the counter-profile elements 41 moving out of the recesses 42 as a result of the force acting on the covering element 6. The covering element 6 is moved by the rotational movement of the coupling wheels 35, 36 along the guide rails 24, 25 until a free second end 58 of the covering element 6 reaches the end switch 55 and the control unit 53 stops the drive motor 52. As the counter-profile elements 41 are configured as sliding elements, they slide in a low-friction manner in the guide rails 24, 25. During the covering of the opening 7, the covering element 6 is therefore slid proceeding from the coupling wheels 35, 36. The covering element 6 is adequately inherently stable for a sliding movement owing to the configuration as a link apron.

During the covering of the opening 7, the covering element 6 is unwound from the winding body 8. As a result, the winding body 8 is rotated in the rotational direction 10 about the rotational axis 5 and reduces a winding diameter D of the covering element 6. This rotational movement is transmitted by the bearing 20 to the first spring end 19, so the first spring end 19 is also rotated about the rotational axis 5. As the counter-bearing 22 is rigidly connected to the shaft 13, the counter-bearing 22 is simultaneously rotated in the rotational direction 10 about the rotational axis 5 during the covering of the opening 7. The transmission ratio of the coupling mechanism 26 is configured in such a way here that the bearing 20 or the winding body 8 and the counter-bearing 22 or the shaft 13 rotate substantially synchronously about the rotational axis 5. This means that upon a rotation of the bearing 20, a rotation of the counter-bearing 22 substantially also takes place. Deviations from this are only produced because of the winding diameter D of the covering element 6 on the winding body 8, as the latter increasingly reduces in the course of the unwinding. Owing to the rotation of the counter-bearing 22 about the rotational axis 5, the spring element 18 is relieved approximately to the extent by which it is tensioned by the rotation of the bearing 20 about the rotational axis 5. Thus, the prestressing force F, which is adjusted in a defined manner during the assembly of the covering device 1, can substantially be kept constant. The spring element 18 prestressed to torsion is thus substantially uniformly loaded, so a fatigue break is prevented or significantly delayed. Furthermore, a covering lift H of the covering device 1 may be dimensioned substantially independently of a dimension A of the spring element 18 in the x-direction, as the prestressing force F or the loading of the spring element 18 remains substantially constant independently of the covering lift H. The covering device 1 according to the invention is thus simply and robustly constructed.

As the coupling wheels 35, 36 are arranged adjacent to the winding unit 2 between the winding unit 2 and the guide rails 24, 25 or the guide 23, only a small spacing has to be overcome by means of the continuous coupling elements 29, 30 between the profile wheels 27 and 31 or 28 and 32. Since the counter-profiles 39, 40 are arranged on the covering element 6, the coupling mechanism 26 is configured or arranged directly on the covering element 6, so the coupling mechanism 26 is constructed comparatively simply and robustly or reliably. In particular, the continuous coupling elements having to run along the entire guide, as is the case in the covering device according to DE 10 2012 200 042 A1, can be avoided. The structure of the coupling mechanism 26 is therefore independent of the covering lift H.

To open the opening 7, the drive motor 52 is rotatably driven in the rotational direction 11. The profile wheels 27, 28 transmit this rotational movement to the continuous coupling elements 29, 30, which in turn rotatably drive the profile elements 31, 32. The coupling wheels 35, 36 are rotatably driven by means of the shafts 33, 34 of the profile wheels 31, 32, the coupling wheels 35, 36, because of the described engagement of the profiles 37, 38 in the associated counter-profiles 39, 40 displacing the covering element 6 in an opening direction 57. The counter-profile elements 41 slide in the guide rails 24, 25 until the covering element 6 actuates the end switch 54 and the control unit 53 stops the drive motor 52. Owing to the prestressing force F and the pulling movement, the covering element 6 is kept under tension during the opening or winding. The prestressing force F and therefore the loading of the spring element 18 remains substantially constant during the winding as the counter-bearing 22 is rotated substantially synchronously with respect to the bearing 20 about the rotational axis 5. The end switches 54 and/or 55 may also be dispensed with when the drive motor 52 is activated accordingly by the control unit 53.

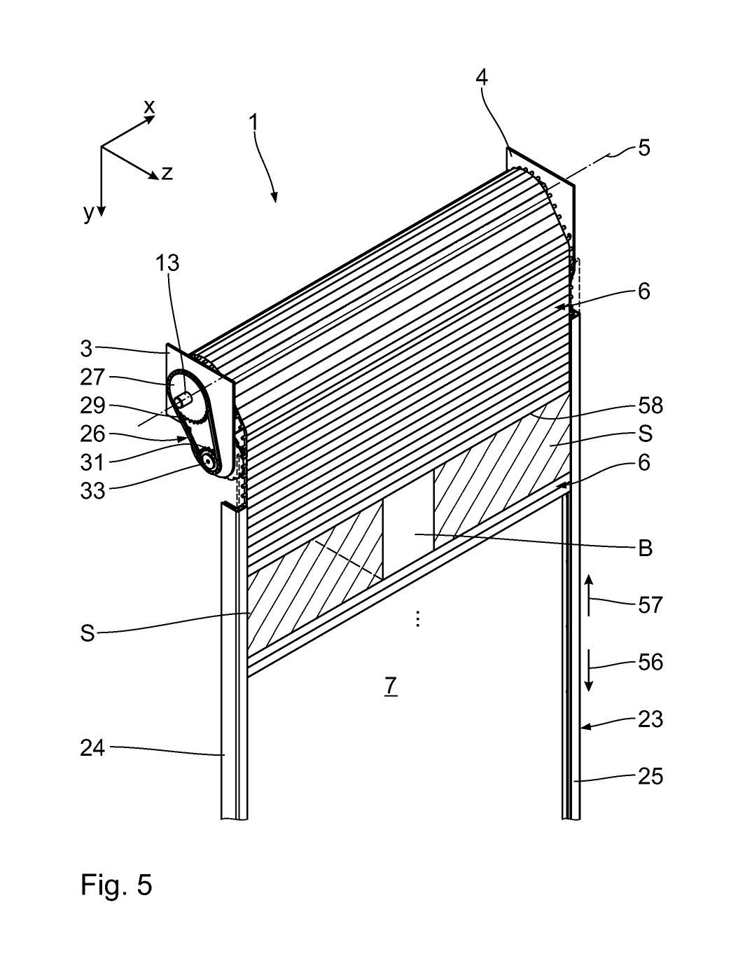

A second embodiment of the invention will be described below with reference to FIG. 5. The covering device 1, in contrast to the first embodiment, has no drive motor of its own. The covering element 6 is fastened by the free end 58 to a component B of a machine, not shown in more detail, the component B being linearly displaceable by means of a drive motor of the machine in the y-direction. The component B is, for example, a tool spindle of a machine tool. The machine tool is not shown in more detail. Upon a movement of the component B in the covering direction 56, the covering element 6 is pulled, with the coupling mechanism 26 rotating the counter-bearing 22 in the manner described substantially synchronously with respect to the bearing 20 about the rotational axis 5 and the loading of the spring element 18 remaining substantially constant. Upon a movement of the component B in the opening direction 57, the covering element 6 is slid and the counter-bearing 22 is rotated substantially synchronously with respect to the bearing 20 about the rotational axis 5 by means of the coupling mechanism 26. The coupling mechanism 26 can, in particular, also have only one coupling wheel 35 with a profile 37 and an associated counter-profile 39.

For the complete covering of the opening 7, the covering device 1 may be constructed symmetrically with respect to the component B and have a further winding unit 2 with an associated covering element 6, which winding unit 2 is arranged on base bodies 3, 4 and has a coupling mechanism 26. This is only indicated in FIG. 5. Furthermore, the covering device 1, in the x-direction laterally next to the component B, may have side coverings S, the length of which can be varied, in particular in the x-direction. This ensures a movement of the component B in the x-direction. Reference is made to the previous embodiment with respect to the further structure and the further mode of functioning of the covering device 1.

What is claimed is:

1. A covering device for openings, comprising:
a winding unit having:
a shaft that is rotatable about a rotational axis;
a winding body that is rotatable about the rotational axis; and,
a spring element for producing a prestressing force (F) acting between the shaft and the winding body, wherein the spring element is mounted by a first spring end on the winding body and by a second spring end on the shaft;
a covering element to cover an opening, wherein the covering element is wound onto the winding body to open the opening, and wherein the covering element is unwound from the winding body to cover the opening; and,
a coupling mechanism for coupling a movement of the covering element to a rotational movement of the shaft, wherein the coupling mechanism has at least one coupling wheel coupled to the shaft, and wherein a profile of the at least one coupling wheel is engaged with a counter-profile arranged on the covering element.

2. A covering device according to claim 1 wherein the opening is a machine opening.

3. A covering device according to claim 1, wherein the counter-profile is formed by individual counter-profile elements.

4. A covering device according to claim 3, wherein the individual counter-profile elements are configured in the shape of a pin.

5. A covering device according to claim 1, wherein the covering element is configured as a link apron, the link apron comprising a plurality of links connected to one another in an articulated manner, wherein the counter-profile is arranged on the links.

6. A covering device according to claim 5, wherein individual counter-profile elements are arranged on the links.

7. A covering device according to claim 3, wherein the counter-profile elements are arranged laterally on the covering element.

8. A covering device according to claim 7, wherein the counter-profile elements are arranged laterally on the end face of the links.

9. A covering device according to claim 1, wherein to secure the engagement of the profile and counter-profile, a counter-holder is associated with the at least one coupling wheel.

10. A covering device according to claim 3, wherein the counter-profile elements are selected from the group consisting of sliding elements, rolling elements and guide elements.

11. A covering device according to claim 3, wherein the counter-profile elements are guided in a guide.

12. A covering device according to claim 1, wherein the shaft is non-rotatably connected to a first profile wheel and the at least one coupling wheel is non-rotatably connected to a second profile wheel; and,
wherein the first and second profile wheels are coupled by a continuous coupling element.

13. A covering device according to claim 1, wherein the coupling mechanism has two coupling wheels arranged on either side of the covering element; and,
wherein the respective profile of the coupling wheels is engaged with the associated counter-profile arranged on the covering element.

14. A covering device according to claim 1 further comprising:
a bearing non-rotatably arranged on the winding body and a counter-bearing non-rotatably arranged on the shaft, wherein the first spring end is arranged on the bearing and the second spring end is arranged on the counter-bearing.

15. A covering device according to claim 1, wherein the spring element is arranged within the winding body.

16. A covering device according to claim 15, wherein the spring element is a helical spring.

17. A covering device according to claim 1, wherein the coupling mechanism is driven by a drive motor.

18. A covering device according to claim 17, wherein the drive motor is coupled to the shaft.
